(19) United States
(12) Patent Application Publication
(10) Pub. No.: US 2016/0234291 A1
(43) Pub. Date: Aug. 11, 2016

(54) FILE SHARING METHOD AND FILE SHARING SYSTEM UTILIZING THE SAME

(71) Applicant: Quanta Computer Inc., Taoyuan City (TW)

(72) Inventors: Tien-Chin FANG, Taoyuan City (TW); Chen-Chung LEE, Taoyuan City (TW); Ping-Chi LAI, Taoyuan City (TW); Chia-Hung LIN, Taoyuan City (TW); Ming-Jen CHEN, Taoyuan City (TW); Ching-Wen LIN, Taoyuan City (TW); Chun-He LIN, Taoyuan City (TW)

(21) Appl. No.: 14/790,519

(22) Filed: Jul. 2, 2015

(30) Foreign Application Priority Data
Feb. 5, 2015 (TW) 104103830

(51) Int. Cl. H04L 29/08; H04L 12/58

(52) U.S. Cl. CPC H04L 67/06; H04L 67/10; H04L 51/08

(57) ABSTRACT

A file sharing system includes: a second, first user device and a cloud server. The first user device uploads a file and sharing information corresponding to the file, wherein the sharing information includes file recipient information of an application corresponding to the second user device. The cloud server receives the file and the sharing information, and transmits a first sharing message to the second user device according to the sharing information. The second user device transmits a request message to the cloud server for requesting the file according to the first sharing message. The cloud server authenticates the second user device according to the request message, and transmits a second sharing message to the application corresponding to the second user device according to the file recipient information when the authentication is successful. The second user device accesses the file according to the second sharing information of the application.

### CROSS REFERENCE TO RELATED APPLICATIONS

This application claims priority of Taiwan Patent Application No. 104103830, filed on Feb. 5, 2015, the disclosures of which are incorporated herein by reference in their entirety.

### BACKGROUND OF THE INVENTION

1. Field of the Invention

The invention relates to a file sharing system and method, and more particularly to a file sharing system and method with improved security.

2. Description of the Related Art

In cloud computing, a cloud may be a computer server or a collection of computer servers that provide file storage services. Typically, a user obtains cloud file storage services from a third party that owns and operates the cloud. Third party cloud storage may be desirable because it frees the user from having to maintain file storage servers. A user may store files on and retrieve files from the cloud through a computer network such as, for example, the Internet. Various cloud-based storage services typically use shared key solutions to enable file sharing and other access functionality through the cloud.

However, once the password is deliberately broken by other people who are not authorized to access the file, the file cannot be protected any longer by the mechanism. Accordingly, there is a need for a novel file sharing system and method that can enhance the security of file sharing on the cloud.

### BRIEF SUMMARY OF THE INVENTION

In a preferred embodiment, a file sharing system is provided in the invention. The file sharing system comprises a first user device, a second user device and a cloud server. The first user device uploads a file and sharing information corresponding to the file, wherein the sharing information at least includes file recipient information of an application corresponding to the second user device, the file recipient information is information about a user to with whom the file is shared. The cloud server is coupled to the first user device and the second user device and receives the file and the sharing information, and transmits a first sharing message to the second user device according to the sharing information. The second user device transmits a request message to the cloud server for requesting the file according to the first sharing message. The cloud server authenticates the second user device according to the request message. The cloud server transmits a second sharing message to the application corresponding to the second user device according to the file recipient information when successfully authenticating the second user device. The second user device accesses the file according to the second sharing information of the application.

In one embodiment of the system, the sharing information further comprises a file sharing deadline, a first sharing link and a first access key. In one embodiment of the system, the step of authenticating the second user device by the cloud server is based on an identity of the second user device, the file sharing deadline, and the first access key. In one embodiment of the system, the first sharing information further comprises a first sharing link and a first access key. In one embodiment of the system, the second sharing information further comprises a second sharing link and a second access key. In one embodiment of the system, the file recipient information is an e-mail account or a mobile phone number. In one embodiment of the system, the application is an e-mail or a mobile phone.

In a preferred embodiment, a file sharing method is provided in the invention. The method comprises: uploading, by a first user device, a file and sharing information corresponding to the file, wherein the sharing information at least includes file recipient information of an application corresponding to a second user device, and the file recipient information is information about a user with whom the file is shared; receiving, by a cloud server, the file and the sharing information, and transmitting a first sharing message to the second user device according to the sharing information; transmitting, by the second user device, a request message to the cloud server for requesting the file according to the first sharing message; authenticating, by the cloud server, the second user device according to the request message; transmitting, by the cloud server, a second sharing message to the application corresponding to the second user device according to the file recipient information after successfully authenticating the second user device; and accessing, by the second user device, the file according to the second sharing information of the application.

In one embodiment of the method, the sharing information further comprises a file sharing deadline, a first sharing link and a first access key. In one embodiment of the method, the step of authenticating the second user device by the cloud server further comprises: authenticating, by the cloud server, an identity of the second user device, the file sharing deadline, and the first access key according to the sharing information. In one embodiment of the method, the first sharing information further comprises a first sharing link and a first access key. In one embodiment of the method, the second sharing information further comprises a second sharing link and a second access key. In one embodiment of the method, the file recipient information is an e-mail account or a mobile phone number. In one embodiment of the method, the application is an e-mail or a mobile phone.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a schematic diagram illustrating a file sharing system in accordance with one embodiment of the invention.

FIG. 2 is a schematic diagram of the cloud server of FIG. 1 according to one exemplary embodiment of the invention.

FIG. 3 is a flow chart illustrating a setting of sharing a file according to an embodiment of the invention.

FIG. 4 is a flow chart illustrating operations for authenticating and accessing a file according to an embodiment of the invention.

FIG. 5 is a flow diagram illustrating a file sharing method according to an embodiment of the present invention and with reference to FIG. 1.

### DETAILED DESCRIPTION OF THE INVENTION

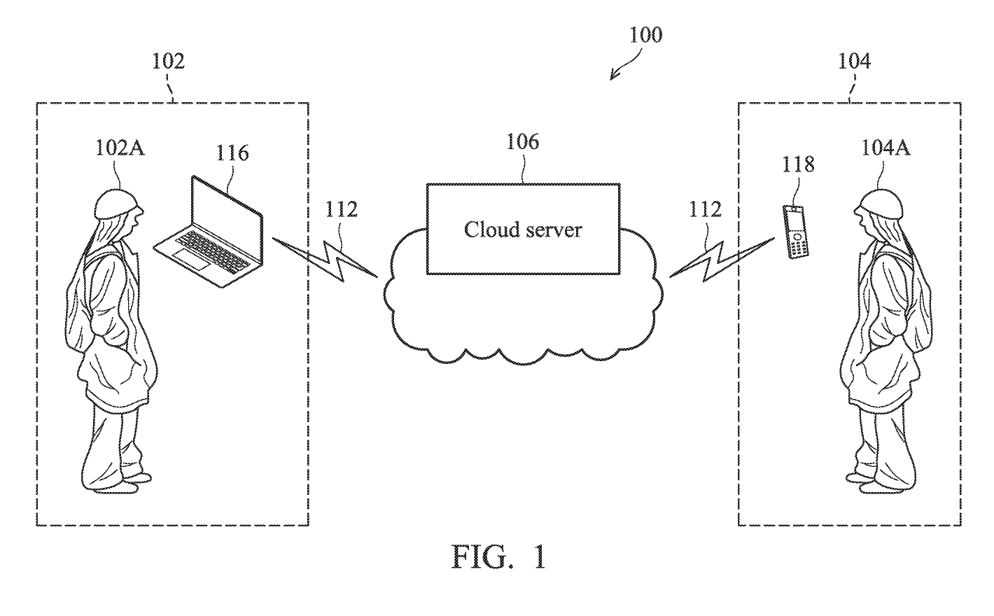

Several exemplary embodiments of the present disclosure are described with reference to FIGS. 1 through 5 which generally relate to a file sharing system and method. It should be understood that the following disclosure provides various embodiments as examples for implementing different features of the present disclosure. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

It is further noted that, unless indicated otherwise, all functions described herein may be performed in hardware or as software instructions for enabling a computer to perform predetermined operations, where the software instructions are embodied on a computer readable storage medium, such as RAM, a hard drive, flash memory or other type of computer readable storage medium known to a person of ordinary skill in the art. In certain embodiments, the predetermined operations of the computer are performed by a processor such as a computer or an electronic data processor in accordance with code such as computer program code, software, firmware, and, in some embodiments, integrated circuitry that is coded to perform such functions. Furthermore, it should be understood that various operations described herein as being performed by a user may be operations manually performed by the user, or may be automated processes performed either with or without instructions provided by the user.

FIG. 1 shows a schematic diagram illustrating a file sharing system 100 in accordance with one embodiment of the invention. The system 100 may include a first user node 102, a second user node 104, and a cloud server 106, wherein each may comprise one or more computers capable of executing computer instructions embodied on a computer readable storage medium.

The first user node 102 provides a user interface, wherein a first user 102A may interact with various components of the system 100 via a first user device 116 such as, for example, a computer, mobile device, smart phone, or any other device capable of interfacing with the system 100. The second user node 104 provides a user interface, wherein a second user 104A may interact with various components of the system 100 via a second user device 118 such as, for example, a computer, mobile device, smart phone, or any other device capable of interfacing with the system 100.

The system 100 also includes a cloud server 106 capable of providing a network storage system for storing data. The first user node 102, the second user node 104, and the cloud server 106 operate over a network such as, for example, the Internet, and are therefore connected via one or more network connections 112. It should be understood that, in some embodiments, the cloud server 106 may be a computer server or a collection of computer servers that comprise a component of the system 100 and is therefore operated by one or more administrators managing the components of the system (i.e., the first user node 102 and the second user node 104). In other embodiments, the cloud server 106 may be provided and/or operated by a third party.

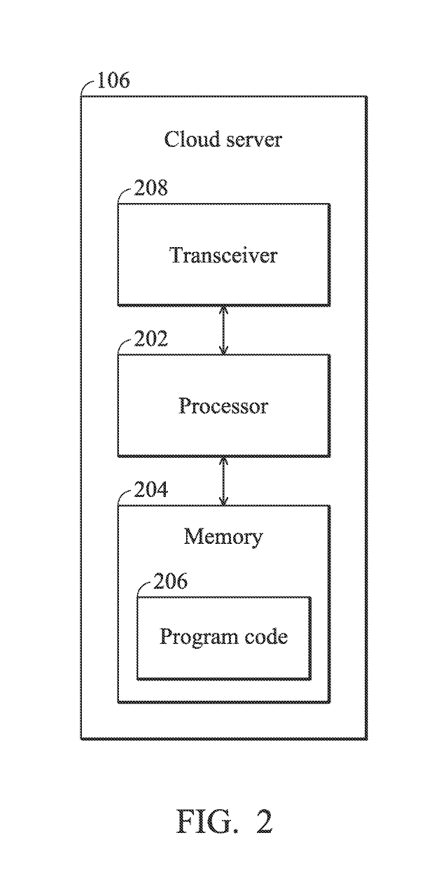

FIG. 2 is a schematic diagram of the cloud server 106 of FIG. 1 according to one exemplary embodiment of the invention. The cloud server 106 may comprise a processor 202, a memory 204, a program code 206. The processor 202 may be a micro-control unit (MCU), application processor, or digital signal processor (DSP) and other device, and is used to execute the program code 206 in the memory code 204 to control operations in the cloud server 106. The transceiver 208 is used to receive and transmit wireless signals, transmit the received signals to the processor 202, and wirelessly output the signals generated by the processor 202. The processor 202 can receive file recipient information set by a user device in advice as a basis for authenticating an identity of a user with whom the file is shared, wherein the file recipient information is information about a user with whom the file is shared, and includes an e-mail, account number, mobile phone number and other information. The processor 202 may also authenticate and record each contact information and login information of the user device in advance to prevent other user equipment from forging the identity of the user device.

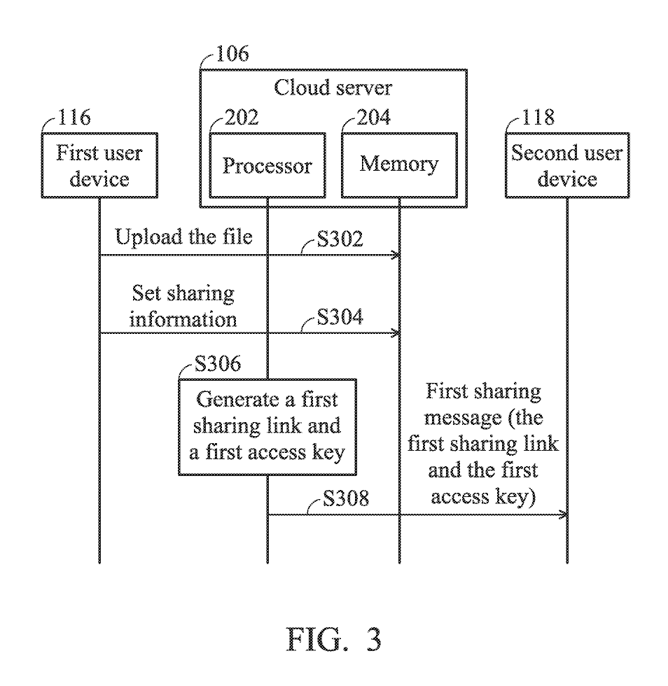

FIG. 3 is a flow chart illustrating a setting of sharing a file according to an embodiment of the invention. In step S302, the first user 102A of the first user node 102 uploads the file to the memory 204 of the cloud server 106 for storage by the first user device 116. Next, in step S304, the first user 102A sets and transmits sharing information corresponding to the file to the memory 204 of the cloud server 106 for storage by the first user device 116, wherein the sharing information includes file recipient information (an e-mail account, a mobile phone number or other information) of an application corresponding to the second user device and the second user 104A accessing the file, share conditions corresponding to the second user 104A (for example, a file sharing deadline corresponding to the second user 104A or a condition determining which sharing group the second user 104A belongs to). After receiving the sharing information, in step S306, the processor 202 of the cloud server 106 generates a first sharing link corresponding to the file and sets a first access key corresponding to the second user 104A. Finally, in step S308, the processor 202 of the cloud server 106 transmits a first sharing message to the second user device 118 of the second user node 104, wherein the first sharing message includes the sharing link corresponding to the file and the first access key corresponding to the second user 104A.

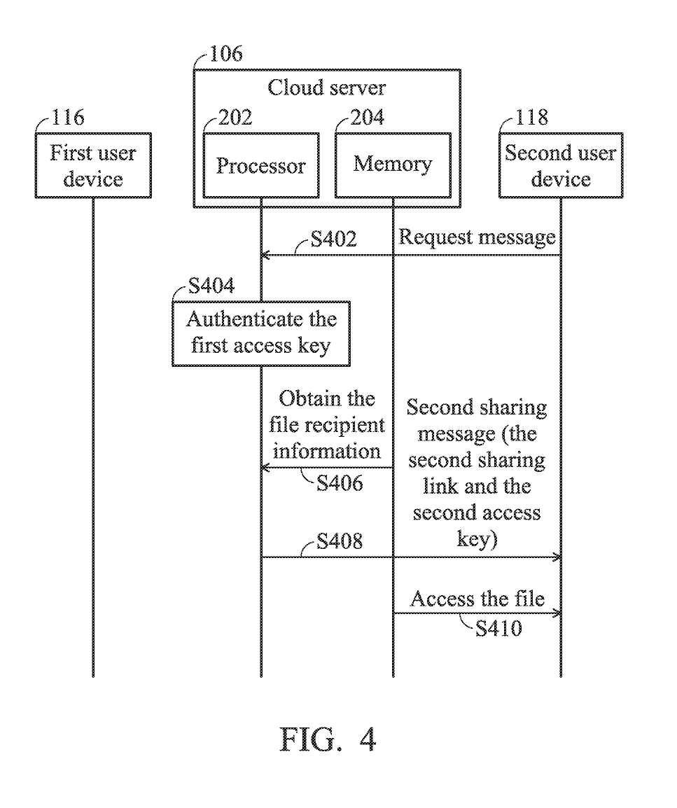

FIG. 4 is a flow chart illustrating operations for authenticating and accessing a file according to an embodiment of the invention. After the second user node 118 in the second user device 104 receives the first sharing information, in step S402, the second user node 118 transmits a request message to the processor 202 of the cloud server 106 for requesting the file according to the sharing link in the first sharing message, wherein the request message includes the first access key. After the processor 202 of the cloud server 106 receives the request message, in step S404, the processor 202 authenticates the first access key. In another embodiment, the processor 202 of the cloud server 106 may also authenticate the sharing conditions corresponding to the second user 104A (for example, the processor 202 may check whether the file sharing deadline corresponding to the second user 104A has expired or whether the second user 104A belongs to the sharing group). When the authentication fails, the processor 202 of the cloud server 106 returns a reject message to the user node accessing the file.

When the authentication is successful, in step S406, the processor 202 of the cloud server 106 obtains the file recipient information of the application corresponding to the second user device 118 from the memory 204. In step S408, the processor 202 of the cloud server 106 transmits second sharing information to an application corresponding to the second user device 118 according to the file recipient information, wherein the second sharing message includes a second sharing link and a second access key. In step S410, the second user 104A receives the second sharing information from the application by the second user device 118. In step S410, the second user 104A accesses the file stored in the memory 106 of the server cloud 204 by the second user device 118 according to the second sharing link and the second access key in the second shared information. In the embodiment, the first sharing link and the second sharing link are different, and the first access key and the second access key are not the same.

The following embodiment describes that a user B successfully accesses a file uploaded by a user A. First, the user A uploads the file to the cloud server by a user device A, and sets share information (a file sharing deadline and sharing groups of a user B), wherein the sharing information includes file recipient information (an email account or a mobile phone number used by the user B and so on). Then, the cloud server transmits the first sharing message to the user device B of the user B via the sharing information, wherein the first sharing message includes a first sharing link and a first access key. After the user device B of the user B receives the first sharing information, the user B clicks on the first sharing link and uses the first access key for authentication, and sends a request message. The cloud server authenticates whether the first access key is correct and authenticates the sharing deadline, the file recipient information and other information. After the authentication is successful, the cloud server transmits a second sharing information according to the file recipient information set by the user A in advance. For example, when the user A sets the email account used by the user B as the file recipient information in advance, the cloud server transmits the second sharing message to the e-mail used by the user B. Finally, the user B uses the second sharing link and the second access key in the second sharing message to access the file in the server cloud. The cloud server authenticates the second access key. After the authentication is successful, the cloud server accesses the file from the memory, and retransmits the file to the user device B used by the user B. It is worth remarking that the user B can use different user devices to login to the e-mail to obtain second sharing information.

The following embodiment describes that a user C steals a first access key of the user B. The user C obtains the first sharing link and the first access key of the user B through illegal means, and uses the first sharing link and the first access key to request the cloud server for authentication by sending a request message. The cloud server authenticates whether the first access key is correct, and performs the steps of authenticating the sharing deadline, whether the user C is the same as the file recipient information, whether the user C is to a member of the sharing group. Because when the user C uses the first sharing link and the first access key, the cloud server does not obtain the login information of the user B, the cloud server determines that “the file recipient information” and “members of the sharing group” of the user C are incorrect, so that the user C cannot read the file.

The following embodiment describes that a user D steals the first access key of the user B, and the user D has the login information of the user. The user D obtains the first sharing link and the first access key of the user B through illegal means, and uses the first sharing link and the first access key to request the cloud server for authentication by sending a request message. The cloud server authenticates whether the first access key is correct, and performs the steps of authenticating the sharing deadline, whether the user D is the same as the file recipient information, whether the user D is to a member of the sharing group. Because the user D has the login information of the user B, the cloud server determines that “the file recipient information” and “members of the sharing group” of the user C are correct. The cloud server transmits the second sharing information according to the file recipient information set by the user A in advance. However, the user D is not a user in the file recipient information set by the user A, so the e-mail or the mobile device of the user D cannot obtain the second sharing information. Therefore, the user D cannot access the file.

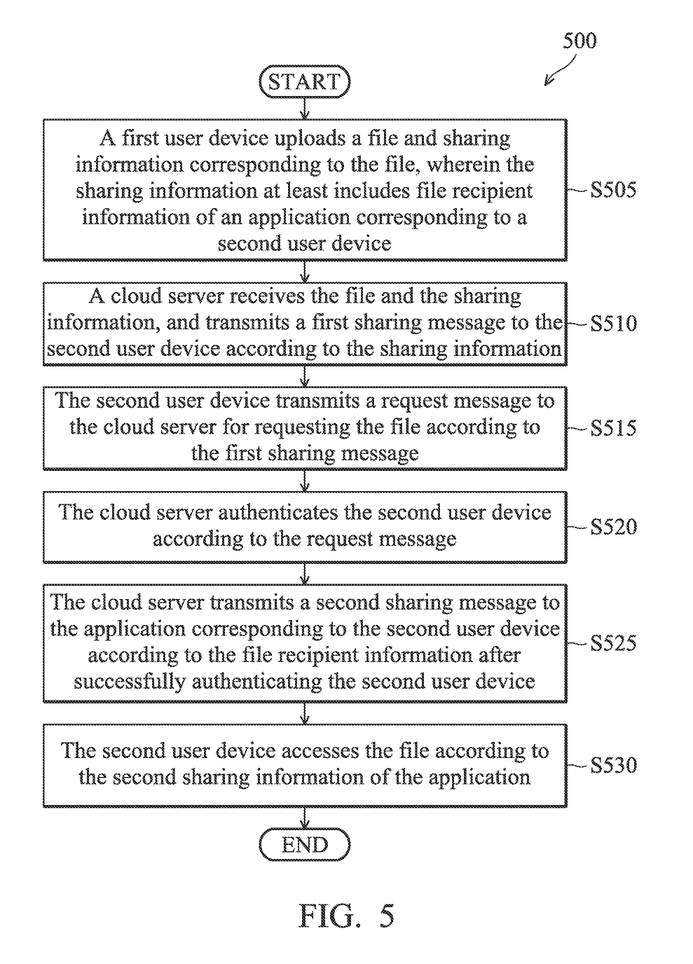

FIG. 5 is a flow diagram 500 illustrating a file sharing method according to an embodiment of the present invention and with reference to FIG. 1. First, in step S505, a first user device uploads a file and sharing information corresponding to the file, wherein the sharing information at least includes file recipient information of an application corresponding to a second user device, and the file recipient information is information about a user with whom the file is shared. In step S510, a cloud server receives the file and the sharing information, and transmits a first sharing message to the second user device according to the sharing information. In step S515, the second user device transmits a request message to the cloud server for requesting the file according to the first sharing message. In step S520, the cloud server authenticates the second user device according to the request message. In step S525, the cloud server transmits a second sharing message to the application corresponding to the second user device according to the file recipient information after successfully authenticating the second user device. In step S530, the second user device accesses the file according to the second sharing information of the application.

Therefore, it can reduce the risk of theft of sharing information to enhance the security of sharing files in the cloud by using the file sharing method of the present invention.

The above-described embodiments of the present invention can be implemented in any of numerous ways. For example, the embodiments may be implemented using hardware, software or a combination thereof. It should be appreciated that any component or collection of components that perform the functions described above can be generically considered as one or more processors that control the function discussed above. The one or more processors can be implemented in numerous ways, such as with dedicated hardware, or with general purpose hardware that is programmed using microcode or software to perform the functions recited above.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A file sharing system, comprising:
a second user device;
a first user device, uploading a file and sharing information corresponding to the file, wherein the sharing information at least includes file recipient information of an application corresponding to the second user device, the file recipient information is information about a user with whom the file is shared; and
a cloud server, coupled to the first user device and the second user device, receiving the file and the sharing information, and transmitting a first sharing message to the second user device according to the sharing information;
wherein the second user device transmits a request message to the cloud server for requesting the file according to the first sharing message; the cloud server authenticates the second user device according to the request message; the cloud server transmits a second sharing message to the application corresponding to the second user device according to the file recipient information when successfully authenticating the second user device; and the second user device accesses the file according to the second sharing information of the application.

2. The file sharing system as claimed in claim 1, wherein the sharing information further comprises a file sharing deadline, a first sharing link and a first access key.

3. The file sharing system as claimed in claim 2, wherein the step of authenticating the second user device by the cloud server is based on an identity of the second user device, the file sharing deadline, and the first access key.

4. The file sharing system as claimed in claim 1, wherein the first sharing information further comprises a first sharing link and a first access key.

5. The file sharing system as claimed in claim 1, wherein the second sharing information further comprises a second sharing link and a second access key.

6. The file sharing system as claimed in claim 1, wherein the file recipient information is an e-mail account or a mobile phone number.

7. The file sharing system as claimed in claim 1, wherein the application is an e-mail or a mobile phone.

8. A file sharing method, comprising:
uploading, by a first user device, a file and sharing information corresponding to the file, wherein the sharing information at least includes file recipient information of an application corresponding to a second user device, and the file recipient information is information about a user with whom the file is shared;
receiving, by a cloud server, the file and the sharing information, and transmitting a first sharing message to the second user device according to the sharing information;
transmitting, by the second user device, a request message to the cloud server for requesting the file according to the first sharing message;
authenticating, by the cloud server, the second user device according to the request message;
transmitting, by the cloud server, a second sharing message to the application corresponding to the second user device according to the file recipient information after successfully authenticating the second user device; and
accessing, by the second user device, the file according to the second sharing information of the application.

9. The file sharing method as claimed in claim 8, wherein the sharing information further comprises a file sharing deadline, a first sharing link and a first access key.

10. The file sharing method as claimed in claim 9, wherein the step of authenticating the second user device by the cloud server further comprising:
authenticating, by the cloud server, an identity of the second user device, the file sharing deadline, and the first access key according to the sharing information.

11. The file sharing method as claimed in claim 8, wherein the first sharing information further comprises a first sharing link and a first access key.

12. The file sharing method as claimed in claim 9, wherein the second sharing information further comprises a second sharing link and a second access key.

13. The file sharing method as claimed in claim 9, wherein the file recipient information is an e-mail account or a mobile phone number.

14. The file sharing method as claimed in claim 9, wherein the application is an e-mail or a mobile phone.
